(19) United States
(12) Patent Application Publication
(10) Pub. No.: US 2017/0217135 A1
(43) Pub. Date: Aug. 3, 2017

(54) SYSTEM AND METHOD FOR CURING FRESH CONCRETE

(71) Applicant: Palmetto Enterprises LLC, Dover, DE (US)

(72) Inventors: Albert Michael Fischer, Fairfield, OH (US); Emmett C. Leopardi, II, South Lebanon, OH (US); Daniel Charles Landrum, Fairfield, OH (US); Joshua Michael Fischer, Hamilton, OH (US)

(73) Assignee: Palmetto Enterprises LLC, Dover, DE (US)

(21) Appl. No.: 15/008,800

(22) Filed: Jan. 28, 2016

(51) Int. Cl. B32B 23/08; B32B 7/12; B32B 23/14; B32B 27/32; B32B 3/10; B32B 27/06

(52) U.S. Cl. CPC B32B 23/08; B32B 3/10; B32B 27/06; B32B 23/14; B32B 27/32; B32B 7/12; B32B 2250/02; B32B 2255/02; B32B 2255/26

(57) ABSTRACT

A concrete curing system and method for maintaining an appropriate amount of moisture along and within fresh concrete for a desired amount of time necessary to ensure the cured concrete obtains its desired properties, that can be used for various environmental conditions and for a variety of structures, that is relatively inexpensive, and provides product and performance consistency and is non-staining.

### BACKGROUND OF THE INVENTION

This invention relates to a curing system and method for curing fresh concrete and more particularly, to a curing system and method for properly curing fresh concrete such that the cured concrete has its desired properties by providing a covering over the exposed surfaces of the fresh concrete to retain the water of hydration therein.

Fresh concrete used in the concrete industry for constructing and repairing pavements, highways, buildings, and other structures are typically coated or covered to retain the water of hydration within the concrete for curing. Proper curing allows the cementitious material within the concrete to properly hydrate and achieve the desired concrete properties. Concrete properties that are influenced by curing include, but are not limited to, surface hardness, abrasion resistance, flexural tension strength, surface cracking, surface strain capacity. Thus, in order for the fresh concrete to properly cure, sufficient water must be present in the concrete mix to hydrate the silicate and aluminate compounds that make up the cement. Either a deficiency or an excess of water in the concrete during the curing process will result in the concrete not achieving its necessary or desired strength and may even result in shrinkage, cracking, or the concrete having relatively low abrasion resistance. Therefore, curing materials, procedures and methods have been developed to ensure that sufficient water is available to the fresh concrete to sustain the rate and degree of hydration for a sufficient time period necessary to achieve the desired concrete properties. The materials, procedures and methods for curing concrete varies, but the principals involved are the same for insuring the maintenance of a satisfactory moisture content and temperature to allow the desired properties to develop. Their selection is contingent on the estimated rate of moisture loss from the fresh concrete and the desired properties to be obtained. Moisture loss depends on the water content of the concrete, the rate in which water can travel through the concrete, the rate of bleeding, the rate of moisture absorption into casings and forms, and the rate of evaporation of water from the surfaces of the concrete. The rate of evaporation from the surfaces is dependent on the temperature and the properties of the cement mixture, surface texture of the concrete, ambient environmental conditions and whether the concrete surfaces are directly exposed to the air or have some form of covering.

During the initial stages of curing, water evaporates at the exposed surfaces of the concrete and depends on environmental factors that include the temperature of the concrete, the temperature of the water on the exposed surfaces, wind speed, and the temperature and relative humidity of the air above the surfaces of the concrete. Systems typically used for maintaining a satisfactory moisture content in fresh concrete include water curing whereby a continuous or frequent application of water through ponding, sprays, steams are applied; open-air curing whereby a saturated cover such as burlap, cotton sheets, dirt, sand, straw, and the like are applied to maintain a relative humidity at the surface of the concrete typically of about 50%; and the use of membrane-forming curing composition over the exposed surfaces of the fresh concrete to reduce the rate of water loss from the concrete by evaporation. In general, when the development of a given strength or durability is critical to the performance of the concrete during construction or service, the minimum duration of curing should be established and the system used to maintain a satisfactory moisture content in the fresh concrete is selected. Accordingly, to be effective, a concrete curing system and method must operate such that the moisture content is maintained within the concrete during the curing period to allow the desired levels of concrete properties to develop as well as to reduce the risk of shrinkage, cracking, dusting, scaling, and crazing of the concrete. To ensure such effectiveness, the concrete industry has developed standard specifications known as the American Society for Testing and Material's (ASTM) Standard Specifications for curing concrete. The ASTM's specifications were developed and provide standards for curing systems and methods with regard to the amount of moisture that can escape through a square meter of the concrete or the amount of moisture to be retained within freshly poured concrete during a period of time to ensure proper and effective curing of the concrete.

While various methods and procedures have been developed for maintaining moisture in fresh concrete, many of the methods and procedures are often impractical for real-world applications or environmental conditions. The application of water, which is free of impurities that could cause deterioration of the concrete, has been used to reduce evaporation and reduce the rate of water loss from the concrete. However, to be effective the application of water must be continuously maintained, which may be difficult depending on the structure. Further, depending on location, an ample supply of water may not be available or is cost prohibited. In addition, environmental conditions could make such methods unsatisfactory for curing the concrete and ensuring that the desired properties are developed. In many applications, such as for large concrete structures, the amount of application water required may be substantial and requires costly drainage or removal operations to eliminate or reduce water from the construction site after use. Curing methods, such as covering the concrete with burlap or other materials, such as cotton or similar fibers, straw and the like which can be soaked with water to reduce moisture loss. However, such methods typically require a continuous supply of water when high temperature and/or low humidity or windy conditions exist. In the event such materials dry they can draw moisture from the surface of the concrete thereby preventing the concrete from establishing the desired properties or, such as for straw and other materials, can be easily displaced or discolor the surface of the concrete. The use of concrete curing compounds consisting essentially of waxes or some organic or synthetic agent which will seal the surface of the concrete have also been shown to be effective in reducing moisture loss to some degree. Unfortunately, such methods often permit the rate of water loss from the fresh concrete by evaporation to be above desired levels (particularly in high temperature, and/or windy, and/or low humidity conditions) such that they are unsatisfactory for many applications requiring the cured concrete to have relatively high strength and durability. Further, such compounds are typically not appropriate for surfaces that are to receive additional concrete, paint, tile, or other treatments requiring a positive bond.

Consequently, a need exists for a system and method for curing for concrete which is effective for maintaining an appropriate amount of moisture along and within fresh concrete for a desired amount of time necessary to ensure the concrete having its desired properties, that can be used for various environmental conditions and for a variety of structures. It would also be desirable to have a system and method for curing concrete that is relatively inexpensive, and provides product and performance consistency and is non-staining.

### SUMMARY OF THE INVENTION

The present invention is directed to an improved concrete curing system which is effective for maintaining an appropriate amount of moisture along and within fresh concrete for a desired amount of time necessary to ensure the cured concrete obtains its desired properties, that can be used for various environmental conditions and for a variety of structures, that is relatively inexpensive, provides product and performance consistency and is non-staining. In a preferred embodiment of the invention the system for curing concrete comprises a top facing outer layer formed from a ultra-violet (UV) resistant material bonded to a hydrating core positioned below the top facing outer layer.

In a preferred embodiment of the invention, the top facing outer layer is formed from a flexible UV resistant material.

In a preferred embodiment of the invention, the top facing outer layer is formed from a permeable or semi-permeable material.

In a preferred embodiment of the invention, the top facing outer layer is formed from a material and has a thickness effective for reducing damage to the concrete caused by contact with routine surface altering objects.

In a preferred embodiment of the invention, the top facing outer layer has a thickness of about 1.5 mils to about 4.0 mils.

In a preferred embodiment of the invention, the top facing outer layer is formed from a light reflecting material.

In a preferred embodiment of the invention, the top facing outer layer is formed from polyester, polypropylene or a combination thereof.

In a preferred embodiment of the invention, the top facing outer layer is bonded to the hydrating core by hot melt glue, a cold glue, or a polyvinyl alcohol (PVOH) and Kymene (or a Kymene equivalent) mixture.

In a preferred embodiment of the invention, the top facing outer layer includes printing thereon.

In a preferred embodiment of the invention, the printing operates to provide advertising.

In a preferred embodiment of the invention, the printing operates to provide information concerning the specifications of the system and/or curing instructions.

In a preferred embodiment of the invention, the hydrating core comprises an encapsulating medium and a fluid absorbent material component contained therein.

In a preferred embodiment of the invention, the fluid absorbent material component is formed from one or more superabsorbent polymers (SAPs).

In a preferred embodiment of the invention, the fluid absorbent material component is formed from one or more superabsorbent polymers, slush powders, hydrogels, or other such materials that operate to absorb and retain water to be used for maintaining hydration of the concrete for a desired concrete curing time period.

In a preferred embodiment of the invention, the desired concrete curing time period is at least 5 days (120 hours).

In a preferred embodiment of the invention, the desired concrete curing time period is at least 28 days (672 hours).

In a preferred embodiment of the invention, the hydrating core includes at least one transfer additive for creating one or more desired surface characteristics to the cured concrete.

In a preferred embodiment of the invention, the at least one transfer additive includes colored dyes and/or inks.

In another preferred embodiment of the invention, the fluid absorbent material component is formed from a non-woven hydrophilic material.

In a preferred embodiment of the invention, the fluid absorbent material component is formed from a non-woven hydrophilic material having superabsorbent polymers.

In a preferred embodiment of the invention, the encapsulating medium is formed from an wet-laid cellulose pulp material.

In a preferred embodiment of the invention, the hydrating core includes a bottom surface for contacting the surface of the cement and wherein the bottom surface has a pattern thereon for creating an opposing mirror pattern on the surface of the concrete.

In a preferred embodiment of the invention, the system includes one or more windows that operate to allow a user to view the surface of the concrete.

In a preferred embodiment of the invention, the system includes a sensor that operates to measure and/or indicates a level of moisture (and/or humidity) and/or temperature along the concrete surface.

Another preferred embodiment of the invention is a method for curing concrete comprising the steps of determining the desired properties for fresh concrete requiring curing, calculating the curing humidity and curing time necessary to provide the desired properties, selecting the specific hydrating core for providing the curing humidity for the curing time, and placing a concrete curing system having the selected hydrating core along and over the surface of the concrete to be cured.

A primary object of this invention, therefore, is to provide a curing system and method for concrete that is effective for retaining water of hydration within fresh concrete.

Another primary object of this invention is to provide a curing system and method for concrete that is effective for inhibiting or preventing excess water evaporation during curing.

Another primary object of this invention is to provide a curing system and method for concrete that provides a barrier which is effective for retaining water of hydration within fresh concrete for a desired concrete curing time period.

Another primary object of this invention is to provide a curing composition for concrete that complies with ASTM specifications.

Another primary object of this invention is to provide a curing system and method for concrete that is relatively inexpensive.

Another primary object of this invention is to provide a curing system and method for concrete that is easy to apply.

These and other embodiments, objects and advantages of the invention will be apparent from the following description and the appended claims.

### BRIEF DESCRIPTION OF THE DRAWINGS

FIG. 1 is a schematic illustration of a side view of an exemplary concrete curing system of the subject application showing a top facing outer layer formed from a ultra-violet (UV) resistant layer, a hydrating core positioned below the top facing outer layer, an encapsulating medium positioned below the top facing outer layer, and a fluid absorbent material component positioned within the encapsulating medium;

FIG. 2 is a schematic illustration of a partial side exploded view of another preferred embodiment of the invention showing hydrating fluid (such as water) used for maintaining surface moisture and humidity being drawn from the fluid absorbent material component by the encapsulating medium and distributed along the surface of the concrete;

FIG. 3 is a schematic illustration of hydrating fluid having at least one transfer additive therein;

FIG. 4 is a schematic perspective illustration of another preferred embodiment of the invention showing the bottom surface of the hydrating core having a three dimensional pattern thereon that operates to create a three dimensional mirror image of the pattern along the surface of the concrete;

FIG. 5 is a graph showing the relative humidity profile comparing an open air curing system, the curing system of the subject invention, and a compound curing system;

FIG. 6 is a graph showing the compressive strength of concrete during curing for an open-air curing system, the curing system of the subject invention, a water submerged curing system and a compound curing system;

FIG. 7 is a graph showing the compressive strength results of testing of concrete samples cured using the concrete curing system of the subject invention in comparison with cement samples using water curing, air curing, and compound curing methods in accordance using the American Society for Testing and Material's Standard Test Method For Water Retention By Concrete Curing Materials (ASTM C-39);

FIG. 8 is a graph showing the splitting tensile strength results of testing of concrete samples cured using the concrete curing system of the subject invention in comparison with concrete samples using water curing, air curing, and compound curing methods in accordance using the American Society for Testing and Material's Standard Test Method For Water Retention By Concrete Curing Materials (ASTM C-496);

FIG. 9 is a graph showing the estimated dynamic modulus of elasticity from ultrasonic pulse velocimetry of concrete samples cured using the system of the subject invention in comparison with concrete samples cured using water curing, air curing, and compound curing methods at 1, 3, 7 and 28 days;

FIG. 10 is a graph showing the estimated compressive strength from rebound surface hardness measurements of concrete samples cured using the system of the subject invention in comparison with concrete samples cured using water curing, air curing, and compound curing methods at 1, 3, 7 and 28 days;

FIG. 11 is a graph showing the internal relative humidity of concrete samples cured using the system of the subject invention compared to concrete samples cured using water curing, air curing, and compound curing methods at 1, 3, 7 and 28 days;

FIG. 12 is a graph showing the internal temperature of concrete samples cured using the system of the subject invention compared to concrete samples cured using water curing, air curing, and compound curing methods at 1, 3, 7 and 28 days;

FIG. 13 is a table showing the chloride permeability classifications for concrete samples cured using the system of the subject invention compared to concrete samples cured using water curing, air curing, and compound curing methods at 7 and 28 days;

FIG. 14 is a schematic illustration of a top planar view of the top facing outer layer showing printing thereon;

FIG. 15 is a schematic illustration of a top planar view of the top facing outer layer showing one or more windows for allowing a user to view the surface of the concrete;

FIG. 16 is a schematic illustration of a top planar view of the top facing outer layer showing a sensor for monitoring the humidity and/or moisture and/or temperature along the surface of the concrete; and

FIG. 17 is an exemplary flow diagram showing the methodology of the subject invention illustrating a preferred embodiment of a method of the subject invention for defining the desired properties of concrete and the required curing humidity and hydrating fluid required to acquire the desired properties and for selecting the hydrating core for providing such curing humidity and hydrating fluid.

### DETAILED DESCRIPTION OF THE INVENTION

The present invention is directed to an improved concrete curing system which is effective for maintaining an appropriate amount of moisture along and within fresh concrete for a desired amount of time necessary to ensure the cured concrete obtains its desired properties, that can be used for various environmental conditions and for a variety of structures, that is relatively inexpensive, and provides product and performance consistency and is non-staining. As used herein the terms “upper” or “above” or “top” refers to the direction that is away from the surface of the concrete. The terms “below” or “lower” or “bottom” refers to the direction that is towards the surface of the concrete.

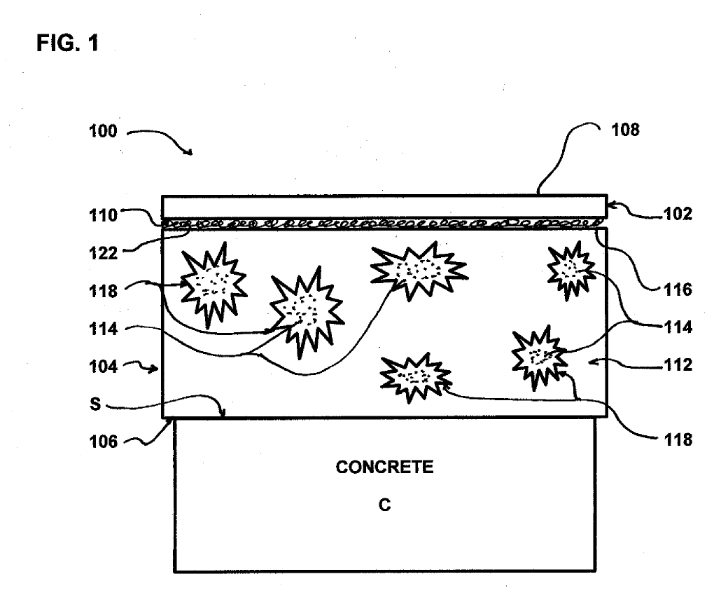

In a preferred embodiment of the invention comprises a top facing outer layer formed from a ultra-violet (UV) resistant layer and a hydrating core positioned below the top facing outer layer. Referring to FIG. 1, a schematic illustration of an exemplary concrete curing system 100 of the subject application is shown having a top facing outer layer and a hydrating core secured together to form a unitary blanket that operates to maintain an appropriate amount of moisture along and within fresh concrete for a desired amount of time necessary to ensure the cured concrete obtains its desired properties. In a preferred embodiment of the invention the concrete curing system 100 comprises a top facing outer layer 102, a hydrating core 104 positioned below the top facing outer layer 102 and having bottom surface 106 for contacting and securing to the surface S of the fresh concrete C by forming a light easy to release hydrostatic bond with the surface S.

In a preferred embodiment of the invention, the top facing outer layer 102 is an open-air layer formed from a relatively flexible material. Preferably, the material has sufficient flexible that permits folding or rolling. In another preferred embodiment of the invention, the material forming the top facing outer layer 102 is a permeable or a semi-permeable material and formed from an ultra violet (UV) resistant plastic material, or more preferably a low density thermoplastic material (such as but not limited to a polyester, a polypropylene, or a combination thereof) having a thickness of about 1.5 mils to about 4.0 mils. In one embodiment, the top facing outer layer 102 includes an outer top surface 108 of aluminum, white or other coloring pigments that operates to reflect light thereby minimizing the sun's potential negative effects on the hydration process. The top facing outer layer 102 further operates as a backing providing a bond site for the hydrating core 104 and to insulate the hydrating core 104 from open-air environmental factors that negatively affect surface hydration and well as for providing a firm or support material that can be manipulated during use of discarded without disrupting or degrading the curing functionality of the concrete curing system 100. The lower surface 110 of the top facing outer layer 102 operates to enable effective bonding with the hydrating core 104.

The hydrating core 104 comprises an encapsulating medium 112 having hydrophobic properties to permit fluid to be drawn or wicked, such as by capillary action. In a preferred embodiment of the invention the encapsulating medium is formed from an wet-laid cellulose pulp material, preferably comprising soft wood pulp having fibers of sufficient length to provide the necessary wicking of the hydrating fluid to distribute the fluid along the surface of the concrete and to operates to provide an effective bond with the lower surface 110 of the top facing layer 102. In a preferred embodiment, the fiber length is optimized to maximize the wicking or drawing characteristics of the layer as well as giving the system additional dry and wet strength. In another preferred embodiment of the invention the encapsulating medium 112 is formed from spunlaced fabrics made from a combination of cellulosic fibers, such as but not limited to Viscose rayon or lyocell, and synthetic fibers, such as but not limited to polyester fibers. The encapsulating medium 112 operates to wick or draw and evenly distribute hydrating fluid (such as water) 114 across the surface S of the concrete C and to provide even wetting to control the concrete surface's relative humidity. The encapsulating medium 112 further operates to provide a clean and easy release surface allowing for removal of the concrete curing system 100 at the end of the curing period without marking or damaging the concrete surface S. The encapsulating medium 112 of the hydrating core 104 further includes an inner surface 116 that operates to bond with a fluid absorbent material component 118 of the hydrating core 104 such as by a lamination process. One such lamination process is provided by EAM Corporation of Jesup, Ga.

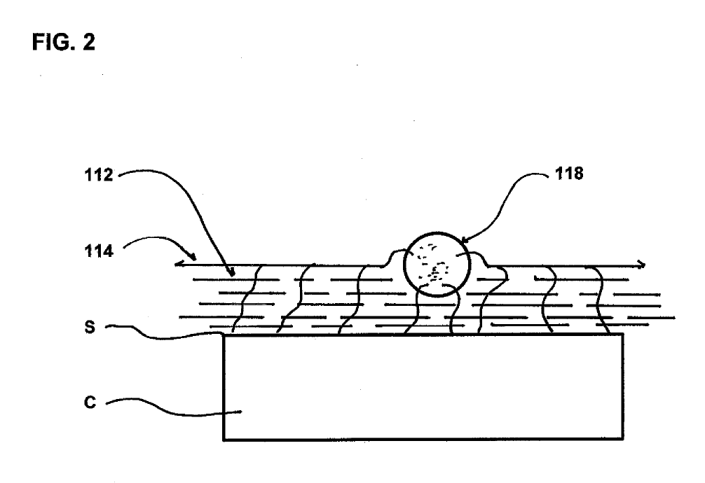

As illustrated in FIGS. 1 and 2, the fluid absorbent material component 118 of the hydrating core 104 is preferably formed from super absorbent polymers (SAP) or slush powders, hydrogels, or other super-absorbent material(s) enclosed within the encapsulating medium 112 and is integrally bonded to the inner surface 116 of the encapsulating medium 112 of the hydrating core 104. The fluid absorbent material component 118 of the hydrating core 104 has a weight of about 20 to about 35 gsm and operates to absorb and retain a desired amount of hydrating fluid 114 (such as water) operating as a reservoir for hydrating fluid 114 which is distributed evenly along the surface S of the concrete C by the encapsulating medium 112 to maintain equilibrium and the relative high humidity along the concrete surface S during curing. It should be understood that the amount of hydrating fluid 114 (such as water) to be contained within the fluid absorbent material component 118 is such that the moisture and relative humidity along the surface S of the concrete C is maintained for a sufficient amount of time to ensure the cured concrete having its desired properties. Accordingly, the desired thickness of the fluid absorbent material component 118 and the amount of hydrating fluid 114 (such as water water) to be held by the fluid absorbent material component 118 can be selected based on the concrete structure, the desired properties of the concrete and the environmental conditions.

In another preferred embodiment of the invention the fluid absorbent material component 118 of the hydrating core 104 is formed from a spunbond non-woven material made from long fibers, bonded together by chemical, mechanical, heat or solvent treatment having a weight of about 30 to about 70 gsm and operates to absorb and store hydrating fluid 114 (such as water) and cooperates with the encapsulating medium 112 to evenly distribute moisture or the hydrating fluid 114 across the surface S of the concrete C. In a preferred embodiment the spunbond woven material is polyester, including, but not limited to Rayon, polypropylene, polyethylene terephthalate (PET) or a combination thereof having superabsorbent polymers within its structure. In a preferred embodiment of the invention the fluid absorbent material component is incorporated into the encapsulating medium 112 having a concentration of about 1-10 grams per square meter.

Preferably the top facing outer layer 102 and the encapsulating medium 112 of the hydrating core 104 are integrally bonded together by a laminating or bonding material 122 applied as a hot melt glue (such as a synthetic rubber based pressure sensitive hot melt adhesive), or a cold glue, or as a mixture of polyvinyl alcohol (PVOH) mixed with Kymene or a Kymene equivalent integrally secures the top facing outer layer and the encapsulating medium together. It should be understood however that the subject invention is not limited to the methods described herein for laminating or bonding the elements of the concrete curing system together but that other conventional adhesives and application processes, such as hot melt extrusion processes or heat gluing adhesive processes, or lamination processes suitable for integrally securing the layers together may also be utilized.

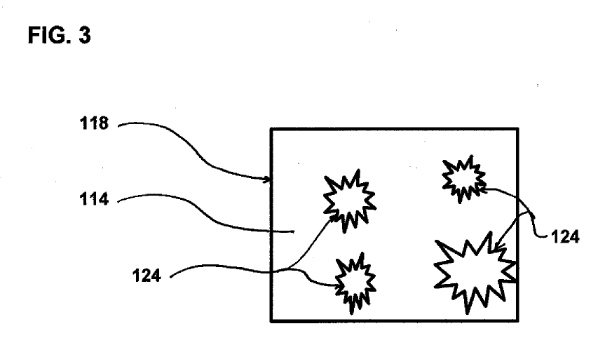

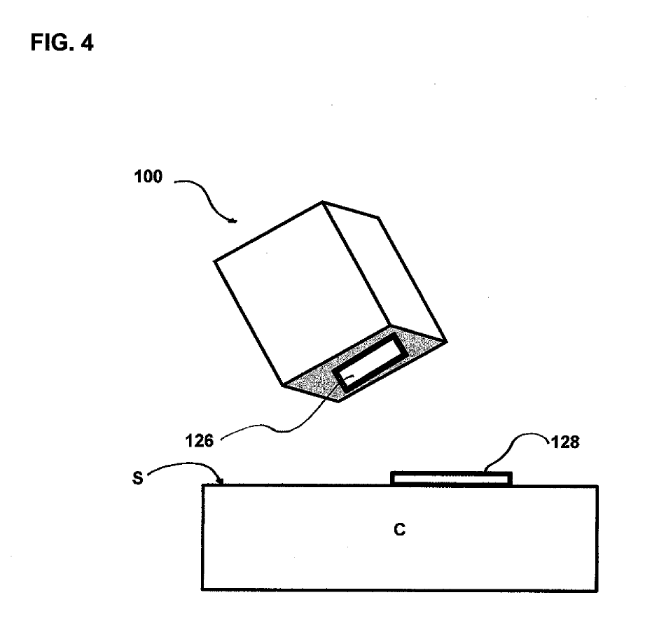

Referring to FIG. 3, in a preferred embodiment of the invention the hydrating fluid 114 (such as water) used for maintaining the surface moisture and humidity along the surface of the concrete can include at least one transfer additive 124, such as colored dyes, inks, and other surface treatments which operate to give a desired characteristic, such as color or color pattern, to the concrete surface S during the curing process. In another preferred embodiment, as shown in FIG. 4, the bottom surface 106 of the hydrating core 104 has a three dimensional pattern. 126 that operates to create a three dimensional mirror image 128 of the pattern 126 along the surface S of the concrete C.

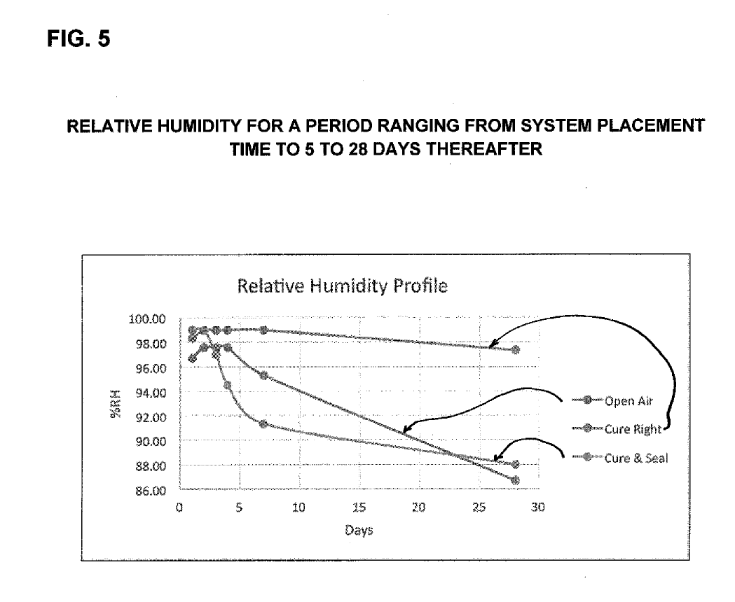

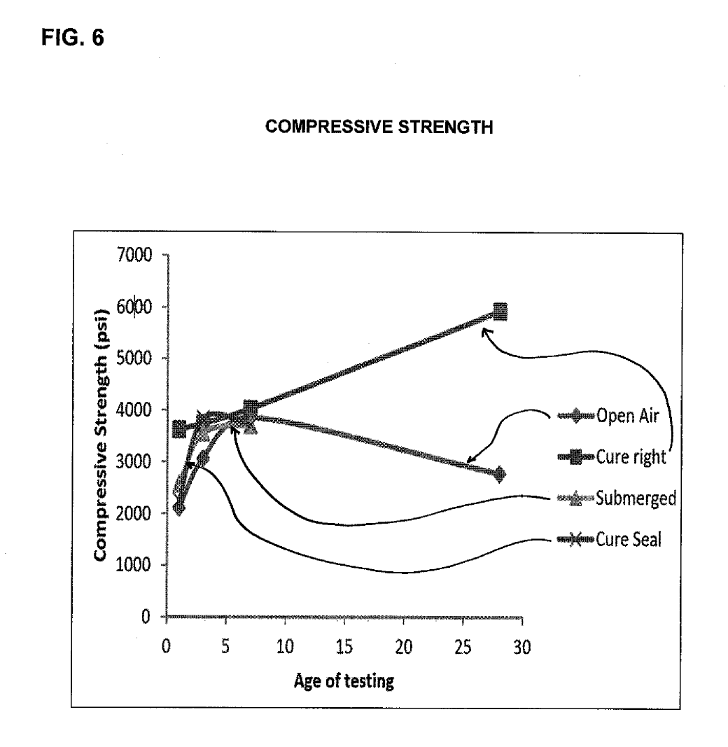

It should be understood that the concrete curing system of the subject invention as described above has a manual or automated placement capability to cover open-air surfaces of fresh concrete once the concrete has begun to set and is capable of supporting the concrete curing system. As shown in FIG. 5, the concrete curing system operates to maintain the covered concrete surface with a relative humidity of 97% for a period ranging from cover placement to any time between about 5 to about 28 days. As shown in FIG. 6, by maintaining the relative humidity at 97% for about 5 to about 28 days results in continued increase in surface compressive strength (up to 50%) as compared to open-air curing, thus allowing a user to purchase a lower cost concrete mix and attain the mix compressive strength rating by controlling the hydration process using the curing system of the subject invention. Further, it should be understood that by using the concrete curing system of the subject invention permits a user to use less concrete (such as reduced slab thickness) and still meet the target design compressive strength.

In order to better understand the advantages of the subject invention, an evaluation of the curing system of the subject invention was tested and compared to several convention curing methods. The example curing systems were each applied to a fresh concrete surface (Type I ordinary Portland cement from Lafarge North America and included crushed stone aggregate composed predominately of rose quartz and with a maximum particle size of 0.5 in and with a water-to-cementitious material ratio (w/cm) of 0.40 and mixed in in accordance with the American Society for Testing and Material's Standard Test Method ASTM C-192). Concrete was cast into cylindrical molds having a diameter of 4.0 in and a length of 8.0 in and in prismatic molds having a width of 12.0 in, a depth of 8.0 in and a length of 18.0 in. Three prisms and 32 cylinders were placed using four different curing systems: 1) water curing in an automated misting room (“water-cured system”), 2) open-air curing at approximated 50% relative humidity (“air-cured system”, 3) the curing system of the subject invention, and 4) a commercial curing compound system (Homax Cure Seal). Except for the subject curing system which was removed after 7 days, specimens remained in the specified condition until the end of the testing period.

The compressive and splitting tensile strength of cylindrical specimens was evaluated at 1, 3, 7, and 28 days in accordance with the specifications of ASTM C39 and ASTM C496, respectively. For the evaluation of compressive strength, test cylinders were capped with neoprene rubber pads and loaded in pure uniaxial compression using a hydraulic load frame with a force application rate of 440 lbf/s. Once the load fell below 85% of the peak, the strength was recorded as the peak load divided by the theoretical cross-sectional area of the cylinder. For the determination of tensile strength, cylinders were loaded in the test frame horizontally, and a load was applied in two diametrically opposed lines parallel to the long axis of the cylinder. Thin plywood bearing strips were used to distribute the load, and the peak load was recorded once the cylinder failed. The splitting tensile strength f_{ct} was recorded as

$${f}_{ct} = \frac{2 P}{π LD}$$

where P is the peak load, L is the cylinder length, and D is the cylinder diameter.

Similarly, the surface hardness (rebound hardness) and ultrasonic pulse velocity in prismatic specimens were evaluated at the same ages in accordance with the specifications of ASTM C805 and ASTM C597, respectively. The surface hardness was measured using a Proceq rebound hammer with digital output. The rebound hammer was firmly depressed perpendicular to the surface of the concrete. Ten measurements were taken at random locations on the face of the concrete prism, and the resulting rebound number and strength estimate was recorded. Care was taken to avoid taking successive readings in the same location as previous measurements. Ultrasonic pulse velocity was determined by placing ultrasonic probes in contact with the surface of the concrete prism at opposing ends of the 18-inch axis. A pulse was fired across the length of the prism and the resulting travel time was recorded. The dynamic modulus of elasticity E_{d} was calculated as

$${E}_{d} = \frac{{V}^{2} ρ ( 1 + μ ) ( 1 - 2 μ )}{1 - μ}$$

where V is the pulse velocity in m/s, ρ is the density of the concrete in kg/m³, and μ is Poisson's ratio. Poisson's ratio for concrete is assumed to be 0.18 and the density is calculated as the specimen mass divided by the theoretical volume of the prism. Although these tests are considered non-destructive, they were performed on different specimens in order to isolate the effect of any potential damage to each specimen. The internal relative humidity of prismatic specimens was measured by embedding a sensor (Rapid RH, manufactured by Wagner Meters) into the surface and reading the internal temperature and relative humidity at the 1, 3, 7, and 28 days. Humidity sensors were deployed in drilled holes at a depth of 40% the total prism depth and prisms were elevated from their supporting surfaces to allow drying from both sides.

Finally, the chloride permeability of cylindrical specimens was evaluated by the rapid chloride permeability test at 7 and 28 days in accordance with the specifications of ASTM C1202. Sawn cylinder segments were epoxy-coated and vacuum-saturated. They were then placed in an electrochemical cell wherein one side of the cylinder was exposed to 0.3 N NaOH and the other to 3% NaCl, and a 60 V electrical potential was applied across the cell. The resulting charge flow is taken to be indicative of the chloride permeability of the concrete.

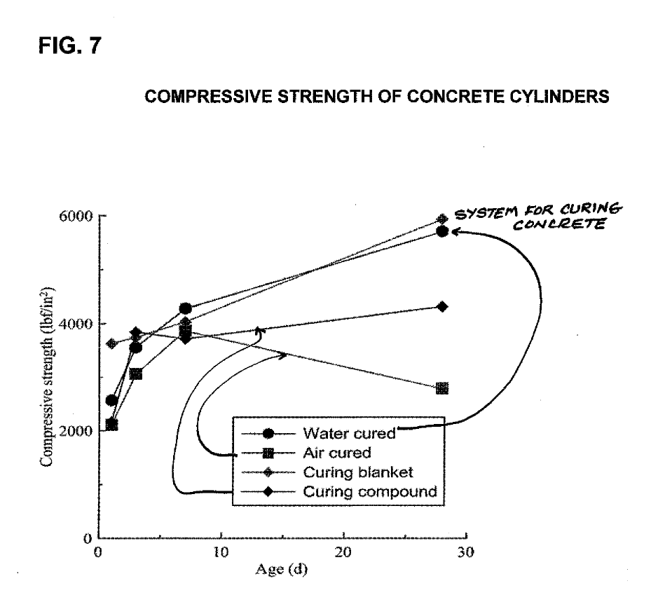

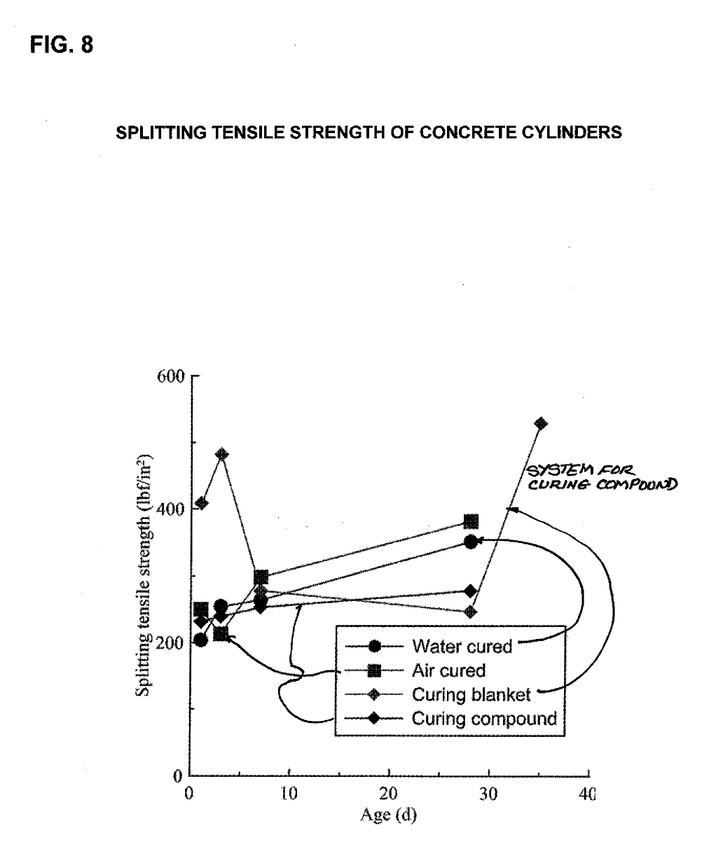

Referring to FIGS. 7 and 8, the compressive and tensile strengths of the concrete cylinders cured using the four curing systems for 1, 3, 7 and 28 days are shown. The early-age compressive strength of concrete cured using the system of the subject invention exceeded that of the water-cured system by about half and at 28 days, the compressive strengths were nearly identical. The early-age and later-age compressive strengths of the air-cured system and with concrete cured using the curing compound system were much lower. The splitting tensile strength of concrete cured using the curing system of the subject invention was also much higher than the concrete cured using the other systems at 1 and 3 days. The tensile strength then decreased significantly at 7 and 28 days; A 35-day tensile strength test indicated that these 7- and 28-day results were likely spurious, as the 35-day tensile strength of this concrete was very high. The tensile strength of the air-cured concrete was slightly higher and that of the water-cured concrete; the concrete cured with the curing compound had the lowest tensile strength.

It should be understood that the splitting tensile test are somewhat suspect. It is normally presumed that the tensile strength of concrete is some fraction of the compressive strength (normally about 10%). Therefore, it would be expected that the tensile strength development would closely mimic the compressive strength development. While the early-age tensile strength of concrete cured using the system of the subject invention should be as much as 50% higher than the other curing systems, the later-age strength results are somewhat spurious. It would be expected that, after about 7 days, the tensile strength of concrete curing using the system of the subject invention and the concrete curing using the water-cured system would be essentially the same. Therefore, the tensile strength data shown should be greeted with some degree of skepticism.

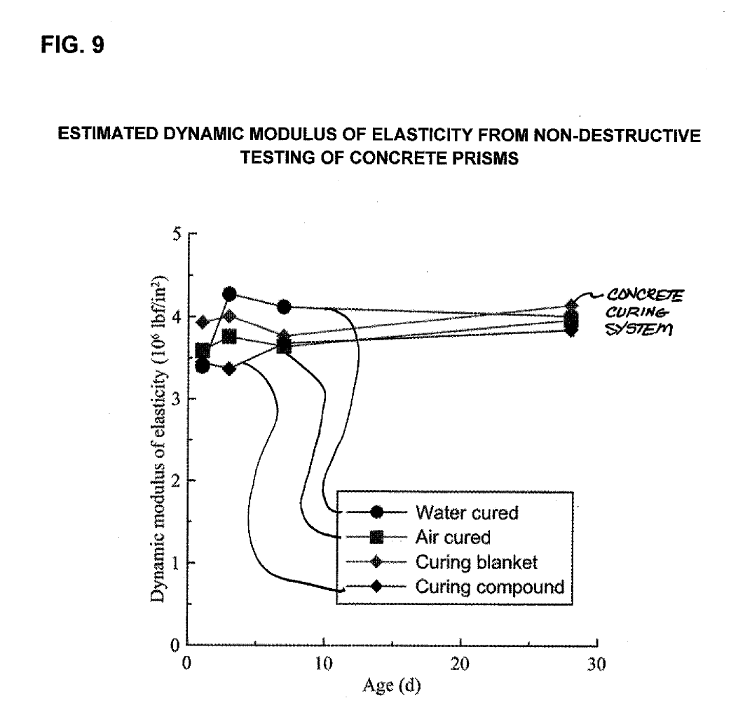

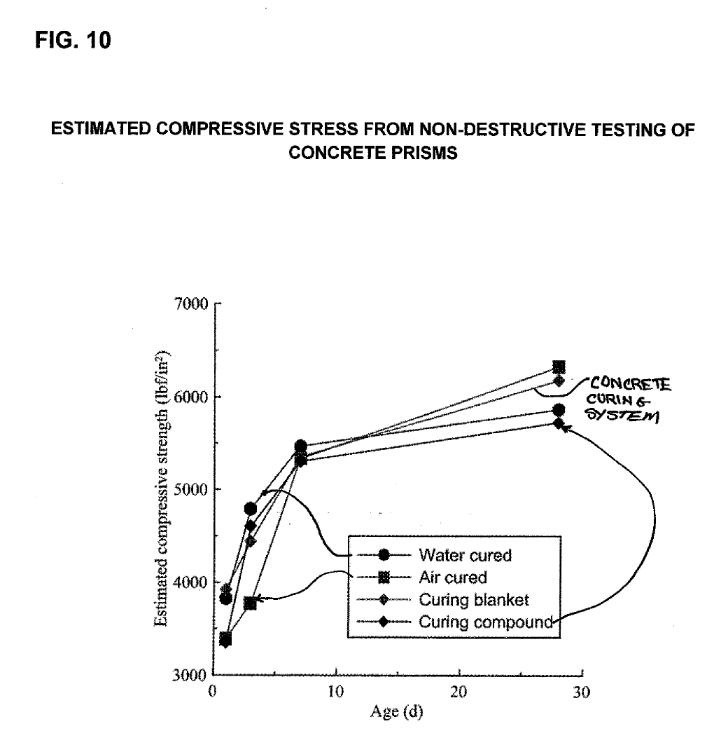

Referring to FIGS. 9 and 10, the estimated dynamic modulus of elasticity from ultrasonic pulse velocimetry and estimated compressive strength from rebound surface hardness measurements in concrete prisms cured using the four curing systems under the four prescribed curing conditions for 1, 3, 7, and 28 days are shown. Concrete cured under the curing system of the subject invention had higher estimated strength and dynamic modulus than the concrete cured using the water-cured system. Concrete treated with the curing compound had the lowest estimated strength and dynamic modulus. There was little difference between the dynamic modulus of elasticity the concrete cured using the air-cured system and the water-cured system, but the surface hardness indicated higher estimated strength in the former. This could be a result of mineral deposits near the surface caused by the egress of internal moisture.

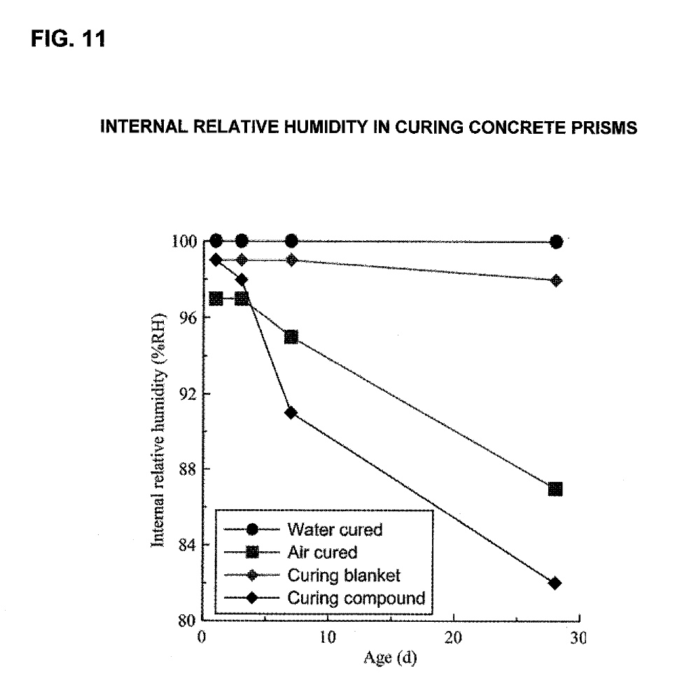

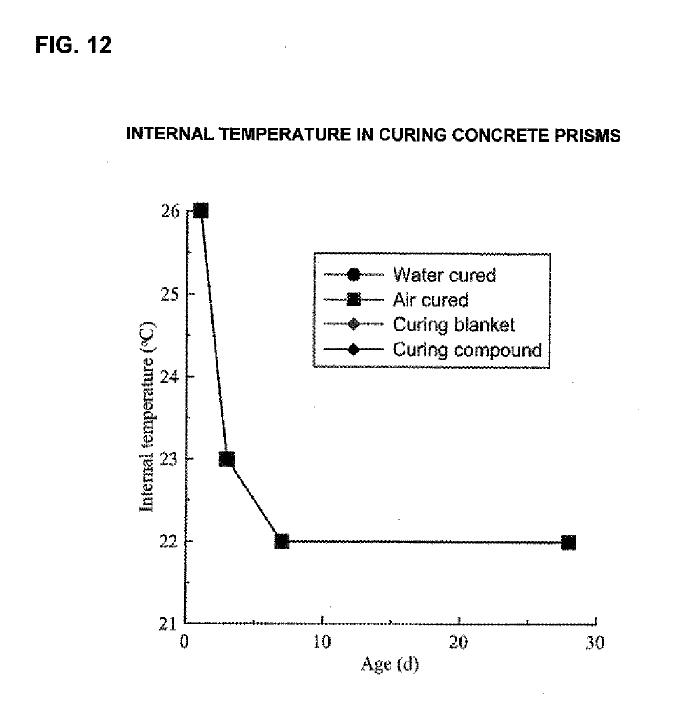

Referring to FIGS. 11 and 12, the internal relative humidity and temperature of concrete prisms cured under the four prescribed curing systems for 1, 3, 7, and 28 days are shown. There was no difference in the internal temperature under the various curing systems. However, the curing system did have a strong effect on the internal relative humidity. The internal humidity was constantly high in water-cured specimens because they were stored at or near 100% RH. In air-cured specimens, and those cured with the curing compound, the internal humidity decreased significantly with time, dropping below 90% RH after 28 days. With the system of the subject invention, the internal relative humidity remained above 95% RH even after the removal of the curing system at 7 days.

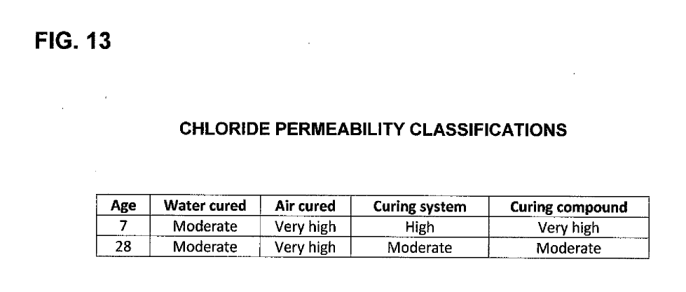

Referring to the table of FIG. 13, the chloride permeability classifications for concrete cylinders cured under the four prescribed curing systems for 7 and 28 days are shown. Due to the poor repeatability and high uncertainty in the results of the testing, it is only permissible to use the categorical classification for comparison, and not the actual charge passed during the test. Concrete cured using the water-cured system was moderately permeable to chlorides at both 7 and 28 days, while concrete cured using the air-cured system was very highly permeable at the same ages. Concrete cured under using the curing system of the subject invention was highly permeable at 7 days but only moderately permeable at 28 days. Similarly, concrete cured with the compound curing system was very highly permeable at 7 days and moderately permeable at 28 days. Classifications of ‘Very high’ chloride permeability were given where the maximum safe current was surpassed during the testing; this is indicative of poor resistance to chloride permeability, which is often observed at early ages.

In summary, the curing system of the subject invention is shown to be effective at limiting moisture egress out of the curing concrete, thereby preserving high relative humidity within the curing concrete. Even though the subject system was removed after 7 days, the internal relative humidity was still above 95% RH even after 28 days of curing. In contrast, the relative humidity of concrete using the air-cured system and concrete cured with the curing compound system was less than 90% RH after 28 days. The effect of sealing the concrete and preventing moisture egress was observed in the mechanical strength and non-destructive test data. Concrete cured using the system of the subject invention has shown to improved compressive strength of concrete over concrete cured using the water-cured system at 1 day, and similar strength at 28 days. In comparison, the compressive strengths of concrete cured using the air-cured system and concrete cured using the curing compound system were much lower throughout the curing process. Similarly, concrete cured using the system of the subject invention showed higher splitting tensile strengths than concrete using the other curing systems. The dynamic modulus of elasticity and estimated compressive strength based on rebound hardness were improved by curing concrete using the curing system of the subject invention. With the exception of air-curing system, the curing system had little effect on the chloride permeability; all three remaining systems resulted in moderate permeability at 28 days. Accordingly, the results of this study show practical improvements in the early-age and later-age (up to 28 days) properties of portland cement concrete cured using the curing system of the subject invention.

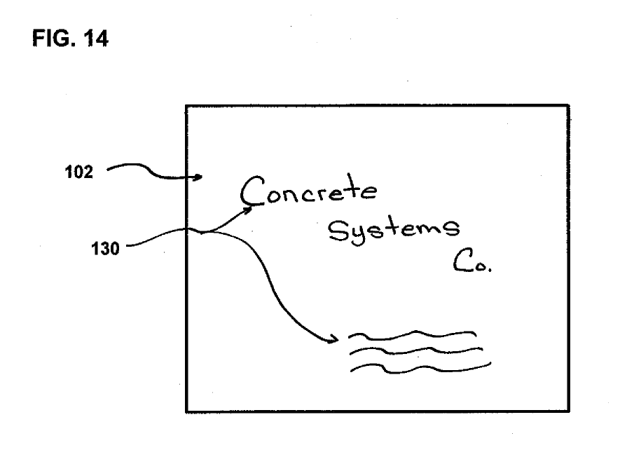

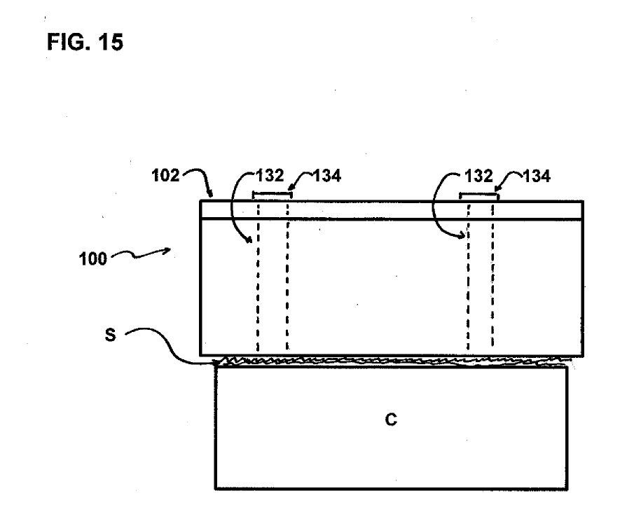

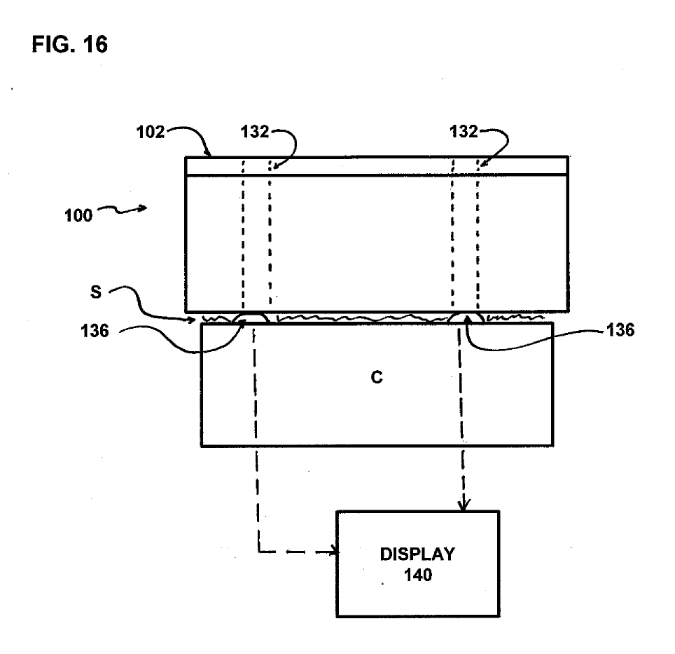

In another preferred embodiment of the invention, as illustrated in FIG. 14, the top facing outer layer 102 includes printing 130 thereon. Preferably the printing 130 can be in the form of advertising and/or curing instructions and/or specifications of the curing system 100. In another preferred embodiment, as shown in FIG. 15, the top facing outer layer 102 of the curing system 100 includes one or more windows 132 that operate to permit a user to view the surface S of the concrete C. In this way a user can examine the surface to determine if the surface has sufficient moisture. In a preferred embodiment, the windows 132 each have a transparent cover 134 that reduces the evaporation rate along the surface S of the concrete C. In another preferred embodiment, as illustrated in FIG. 16, the curing system 100 includes one or more sensors 136 positioned along the surface S of the concrete C and operate to transmit data 138, such as humidity and/or moisture contact and/or temperature along the surface S. In a preferred embodiment, the sensors 136 include RFID transmitters (either passive or active) that transmit a single to a display 140. In another preferred embodiment of the invention the display 140 is attached to the sensors 136 for viewing by a user, such as through one or more of the windows 132.

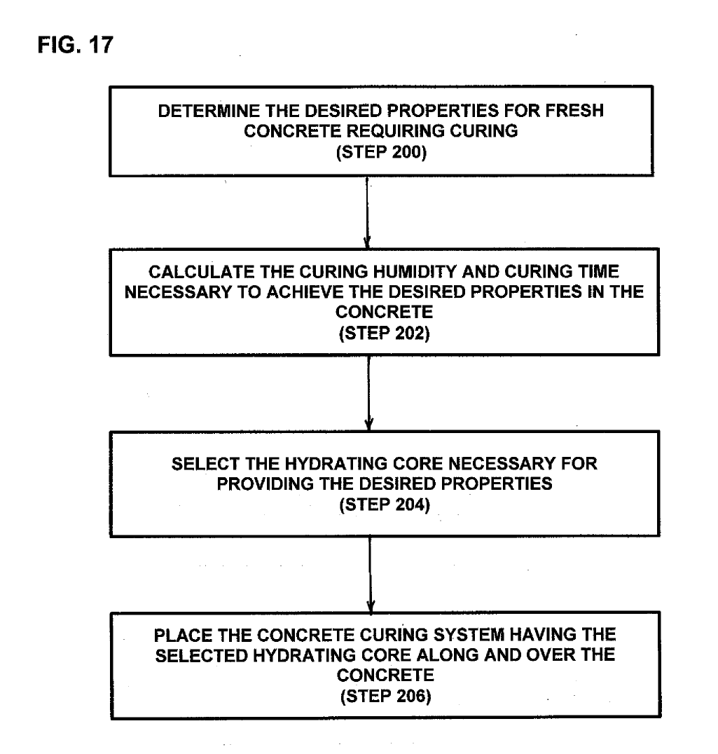

Another preferred embodiment of the invention, as illustrated in FIG. 17, is a method for curing concrete comprising the steps of determining the desired properties for fresh concrete requiring curing (step 200). It should be understood that the desired properties include, but are not limited to surface hardness, abrasion resistance, flexural tension strength, surface cracking, surface strain capacity and are conventionally determined based on various parameters that include, but are not limited to the type of concrete structure, the purpose of use of the structure, environmental conditions that the structure will be subjected. The curing humidity and the curing time necessary to provide the concrete with the desired properties is then calculated using conventional methods (step 202). The curing humidity and curing time are determined based on various concrete specifications including, but not limited to the type and composition of the cement forming the concrete, the shape and thickness of the concrete structure, the surface area of exposed surfaces of the concrete, the desired properties to be obtained, and the environmental conditions. Based on the determined required curing humidity and curing time, the specific hydrating core (size and operation capacity, such as the amount of hydrating fluid held by the fluid absorbent material component) of the concrete curing system is selected (step 204) and the concrete curing system with the selected hydrating core is placed along and over the fresh concrete for the required curing time (step 206). It should be understood that the amount of hydrating fluid contained and stored by the fluid absorbent material component of the hydrating core can vary and can be conventionally calculated depending of the required humidity and curing time as well as the environmental conditions during curing. Accordingly, for an illustrating example, a relatively large hydrating core capable of storing and distributing a large amount of hydrating fluid can be used when the environmental conditions are relatively hot or the relative humidity is low and a relatively smaller hydrating core can be used when environmental conditions are such that the temperature is lower and/or when the relative humidity is high. Thus, the size of the concrete curing system and water usage can be optimized thereby significantly reducing costs of operation.

Accordingly, the curing system of the present invention is effective for preventing excessive loss of water from fresh concrete by evaporation thereby insuring the maintenance of a satisfactory moisture content necessary for the proper curing of the concrete. Further, the concrete curing system of the present invention does not result in discoloration of the concrete surface, provides protection of the surface during curing, is non-toxic, ecologically acceptable, relatively inexpensive, and may be easily applied to the surface of freshly laid pavement, highways, buildings and the like.

While the curing system herein described constitutes a preferred embodiment of this invention, it is to be understood that variations may be made therein without departing from the scope of the invention which is defined in the appended claims.

1. A concrete curing system for using placing over the surface of fresh concrete, the concrete curing system comprising:
a top facing outer layer having an outer top surface and a lower surface,
a hydrating core positioned below said top facing outer layer and having a top surface for bonding to the lower surface of said top facing outer layer and a bottom surface for contacting the surface of the fresh concrete;
wherein said top facing outer layer is formed from a permeable or a semi-permeable low density thermoplastic material; and
wherein said hydrating core comprises an encapsulating medium formed from a cellulose pulp material and a fluid absorbent material component positioned within said encapsulating medium for storing hydrating fluid and wherein said encapsulating medium operates to draw (or wicks) said hydrating fluid from said fluid absorbent material component and evenly distributes said hydrating fluid along the surface of the concrete.

2. The concrete curing system of claim 1 wherein said fluid absorbent material component is formed from super absorbent polymers (SAP) or slush powders, or hydrogels.

3. The concrete curing system of claim 1 wherein said top facing outer layer is formed from a flexible UV resistant material.

4. The concrete curing system of claim 1 wherein said top facing outer layer has a thickness of about 1.5 mils to about 4.0 mils.

5. The concrete curing system of claim 1 wherein said top facing outer layer is formed from a light reflecting material.

6. The concrete curing system of claim 1 wherein said top outer layer is formed from polymer, polypropylene or a combination thereof.

7. The concrete curing system of claim 1 wherein said outer top surface layer is bonded to said encapsulating medium by an adhesive bond formed from a hot melt glue, a cold glue, or a polyvinyl alcohol (PVOH) and Kymene (or a Kymene equivalent) mixture.

8. The concrete curing system of claim 1 wherein said hydrating fluid comprises at least one transfer additive effective for creating one or more desired surface characteristics to the cured concrete.

9. The concrete curing system of claim 8 wherein said at least one transfer additive includes a colored dye or ink.

10. The concrete curing system of claim 1 wherein said encapsulating medium includes a bottom surface for contacting the surface of the concrete and wherein the bottom surface has a pattern thereon for creating an opposing mirror pattern on the surface of the concrete.

11. The concrete curing system of claim 1 wherein said fluid absorbent material component is formed from spunbond non-woven material made from long fibers, bonded together by chemical, mechanical, heat or solvent treatment.

12. The concrete curing system of claim 11 wherein said fluid absorbent material component has a weight of about 30 to about 70 gsm.

13. A concrete curing system for using placing over the surface of fresh concrete, the concrete curing system comprising:
a top facing outer layer having an outer top surface and a lower surface,
a hydrating core positioned below said top facing outer layer and having a top surface for bonding to the lower surface of said top facing outer layer and a bottom surface for contacting the surface of the fresh concrete;
wherein said top facing outer layer is formed from a permeable or a semi-permeable low density thermoplastic material; and
wherein said hydrating core comprises an encapsulating medium formed from a cellulose pulp material and a fluid absorbent material component positioned within said encapsulating medium for storing hydrating fluid;
wherein said fluid absorbent material component is formed from super absorbent polymers (SAP) or slush powders, or hydrogels; and
wherein said encapsulating medium operates to draw or wick said hydrating fluid from said fluid absorbent material component and evenly distributes said hydrating fluid along the surface of the concrete.

14. The concrete curing system of claim 13 wherein said top facing outer layer is formed from a flexible UV resistant material and/or light reflecting material.

14. (canceled)

16. The concrete curing system of claim 13 wherein said top outer layer is formed from polymer, polypropylene or a combination thereof.

17. The concrete curing system of claim 13 wherein said hydrating fluid comprises at least one transfer additive effective for creating one or more desired surface characteristics to the cured concrete.

18. A concrete curing system for using placing over the surface of fresh concrete, the concrete curing system comprising:
a top facing outer layer having an outer top surface and a lower surface,
a hydrating core positioned below said top facing outer layer and having a top surface for bonding to the lower surface of said top facing outer layer and a bottom surface for contacting the surface of the fresh concrete;
wherein said top facing outer layer is formed from a permeable or a semi-permeable low density thermoplastic material; and
wherein said hydrating core comprises an encapsulating medium formed from a cellulose pulp material and a fluid absorbent material component is positioned within said encapsulating medium for storing hydrating fluid;
wherein said fluid absorbent material component is formed from spunbond non-woven material made from long fibers, bonded together by chemical, mechanical, heat or solvent treatment; and
wherein said encapsulating medium operates to draw said hydrating fluid from said fluid absorbent material component and evenly distributes said release fluid along the surface of the concrete.

19. The concrete curing system of claim 18 wherein said top facing outer layer is formed from a flexible UV resistant material and/or light reflecting material.

20. The concrete curing system of claim 18 wherein said top outer layer is formed from polymer, polypropylene or a combination thereof.

21. The concrete curing system of claim 18 wherein said bottom surface comprises at least one transfer additive effective for creating one or more desired surface characteristics to the cured concrete.
